(19) United States
(12) Patent Application Publication
(10) Pub. No.: US 2015/0125580 A1
(43) Pub. Date: May 7, 2015

(54) METHODS, APPARATUS, AND PROCESS FOR THE MAKING OF EDIBLE PRODUCTS USING IRREVERSIBLE ELECTROPORATION AND/OR ELECTROLYSIS

(71) Applicant: Fernando Qvyjt, Memphis, TN (US)

(72) Inventor: Fernando Qvyjt, Memphis, TN (US)

(21) Appl. No.: 14/533,035

(22) Filed: Nov. 4, 2014

Related U.S. Application Data
(60) Provisional application No. 61/899,838, filed on Nov. 4, 2013.

(51) Int. Cl. A23L 3/32

(52) U.S. Cl. CPC A23L 3/325; A23V 2002/00
USPC 426/244; 204/194

(57) ABSTRACT

A method, apparatus, and system for the making of edible products for humans and animals, such as pets, using low voltage irreversible electroporation and or electrolysis device(s). In particular, aspects of this technology relate to the making of foods, food ingredients, supplements, and bio-components for human or animal consumption. Specifically, aspects of the technology relate to the making of foods, food ingredients, supplements, and bio-components that do not contain preservatives for microbiological control, and are neither sterilized nor pasteurized by using chemical, thermal or radioactive methods or combinations thereof.

### CROSS REFERENCE TO RELATED APPLICATION

This non-provisional patent application claims priority to and the benefit of U.S. Provisional Patent Application No. 61/899,838, titled Methods, Apparatus, and Process for the Making of Edible Products using Irreversible Electroporation and/or Electrolysis, filed Nov. 4, 2013, and which is incorporated herein in its entirety by reference thereto.

### TECHNICAL FIELD

This invention relates to a method and system for the making of edible and consumable products for humans and animals, such as pets, using irreversible electroporation and or electrolysis device(s). In particular, aspects of this invention relate to the making of foods, food ingredients, supplements, and bio-components for human or animal consumption. Specifically, aspects of the invention relate to the making of foods, food ingredients, supplements, and bio-components that do not contain preservatives for microbiological control, and are neither sterilized nor pasteurized by using chemical, thermal or radioactive methods or combinations thereof.

The technology of the present disclosure is also related to the technologies described and disclosed in U.S. Provisional Patent Application Nos. 61/730,750, 61/671,520, 61/670,572, and 61/595,547; U.S. Patent Non-Provisional patent application Ser. No. 13/758,834; and PCT Patent Application No. PCT/US13/24661, all of which are incorporated herein by reference thereto.

### BACKGROUND

Conventional methods of making foods, food ingredients, supplements, and bio-components for human or animal consumption imply that they are created ensuring their safety by carefully controlling the process from the farm to the consumer. Safety includes both chemical and microbiological control of the product. Microbiological control is strongly emphasized and its main objective is to eliminate microorganisms or prevent their growth.

Refrigeration, freezing, drying, and controlling water activity (i.e. like adding polyols, salt, sugar, etc.) are the main processes used to prevent microbiological growth, while pasteurization, sterilization, membrane processing, sanitation, and cleaning are used to minimize its content. Other known methods to prevent or control microbiological growth include the controlled use of micro-organisms and fermentation processes. Chemicals are added to preserve foods and freshness and extend their shelf life.

While preservatives in foods are designed to prevent microbial growth and spoilage, they could have adverse effects on the body that can vary with age and health status (e.g., breathing difficulties, behavioral changes, heart damage, cancer, etc.).

Pulsed Electric Fields (PEF) using pulses of high voltages between 20,000-60,000 volts/cm have been used as a method of non-thermal food preservation. The advantage of PEF is that it avoids or greatly reduces the detrimental changes of the sensory and physical properties of foods caused by the traditional heat treatments for pasteurization and/or sterilization. However, the current high pulse voltages used in PEF are inefficient and make the process substantially cost prohibitive. The radiation and thermal treatments are also costly and are hazardous in the work site. The high levels of chlorine and fluoride levels used in water treatment systems are not environmental friendly, corrosive, and give a chlorine taste consumers do not like too much.

The inventor has identified that there is a need for methods, apparatus, and processes for making or processing new foods, food ingredients, supplements, and bio-components for human or animal consumption which do not spoil, have better sensory and physical characteristics, provide natural nutrition retention, they are not detrimental for health, do not contain chemical additives, and eliminate synergistic effects due to the presence of preservatives or use of thermal or radiation methods.

### SUMMARY

The present technology provides methods and processes for making foods, food ingredients, supplements, and/or bio-components that that overcome drawbacks in the prior art and provide additional benefits. A brief summary of some embodiments and aspects of the technology are presented. Thereafter, a detailed description of the illustrated embodiments is presented, which will permit one skilled in the relevant art to understand, make, and use the technology. One skilled in the art can obtain a full appreciation of aspects of the technology from the subsequent detailed description, read together with the figures, and from the claims, which follow the detailed description.

Aspects of at least one embodiment of the present technology provide methods, apparatus, and processes for making foods, food ingredients, supplements, and bio-components that do not contain preservatives for microbiological control, and neither they are sterilized nor pasteurized during the process by using chemical, thermal or radioactive methods or combinations thereof. Instead they will be made by using Low Voltage Irreversible electroporation and or electrolysis units Aspects of embodiments of the technology also provide commercially practical methods of making human consumption products that do not contain chemical additives and are not treated using thermal or radiation methods for microbial control.

At least one embodiment of the present disclosure provides apparatus and/or a system configured with low voltage irreversible electroporation and or electrolysis units which can be, but are not limited to, the various types as described in general as follows:

a) Devices that include one or more portions that can be activated electrically that engage the food product and that contain conductive polymeric materials (e.g. anti-microbial ion exchange resins, ceramic ion-exchange resins, etc.) or polymer blends containing conductive polymeric materials subjected to a low voltage or not, specifically food grade materials. These devices are configured such that, when the device is activated and the microorganism touches the material, the microorganism is killed in less than about 1 second.

b) Devices that include one or more portions that engage the food product and that contain peptides or polypeptides in which the microorganisms are separated or killed when they attach to the polypeptide layer or membrane, or to polypeptides attached to a food grade material (e.g. stainless steel, SiO₂, cermets, ceramics, polymers, etc.) and are subjected or not to a low voltage, specifically peptides or polypeptides for food contact.

c) High intensity pulsed electric field (PEF) devices using pulses at low voltage, typically voltages between approximately 1×10⁻²⁴-2000 Volts, preferably approximately 1×10⁻²⁴-1000 Volts and even more preferably between approximately 1×10⁻²⁴-440 Volts, with electric fields in the magnitude of approximately 50 V/cm to 60 KV/cm, pulse lengths between approximately 10⁻¹² to 1 second with a duration of approximately 10⁻¹² to 100 seconds, using electrodes arranged in parallel sequence, side by side, with an electric insulator between electrodes. The PEF treatment in accordance with one embodiment can be conducted at ambient, sub-ambient, or slightly above ambient temperature conditions for less than 1 second, and with minimized energy loss that would change the temperature of the flowing product material to be treated. The electrodes are made of materials that minimize an electrolysis phenomena although electrolysis per se or in combination with irreversible electroporation can also be used as treatment for microbiological control. The electrodes are made with food grade components, such as metals, cermets, ceramics, polymers, etc. In at least one embodiment the electrodes are of inert nature (e.g. precious metals, carbon, conductive polymers, oxide base inert-electrodes, etc), although food grade highly stable stainless steel could be used, specifically for food grade. When the microorganism touches the electric field it is killed in less than 1 second and/or in combination with electrolysis the ions enhance the treatment on killing the microorganisms.

In accordance with aspects of disclosure, the food or food component or biological component containing the unwanted microorganisms is treated in reactors of the types such as pipes, coiled pipes, agitators, blenders, mixers, forced-flow devices such as parallel plate reactors, counter-flow reactors, conical, nozzle-type, box-type, grinders, slicers, peelers and cutters, emulsifiers, filters, packed columns, pulpers and finishers, tanks, dryers, multi-tube exchangers, votators, scrapers, plate, plate-fin, spiratherm-type, blanchers, shell and tube, conveyors, etc. and combinations thereof.

The methods, apparatus, and processes are provided for making of foods, food ingredients, supplements, and/or bio-components for human or animal consumption without the use of chemical preservatives, thermal treatments, or radiation treatments for microbiological control, and without the addition of chemicals to alter the pH as a preservation technique. The method and process in accordance with at least one embodiment utilizes apparatus for a process that involves a food processing operation, such as (1) separation or extraction, (2) mixing, (3) blending, (4) homogenization, (5) cooking, (6) cooling, (7) filling, and/or other processing operation, and the food processing operation is combined with a treatment operation that includes (8) in line low-voltage irreversible electroporation and or electrolysis treatment applied in a selected one or more of the food processing operations depending upon the product application, nature of the components before or after any of steps 1 through 7 to make edible human and or animal/pet consumption products in which the ingredients to be used can be fruit or vegetable juice/extracts/pulps (and/or water), meats, fish, seafood, modified proteins modified polysaccharides, natural or artificial flavors, natural or artificial aromas, natural or artificial sweeteners, natural or artificial essential oils, fortifying ingredients and/or food grade additives, or chemicals for pharmaceutical purposes for human or animal/pet consumption. These and other aspects of the technology will be apparent to those skilled in the art from the description of the technology as follows.

### BRIEF DESCRIPTION OF DRAWINGS

FIG. 1 is a schematic illustration of a system in accordance with an embodiment of the present disclosure.

### DETAILED DESCRIPTION

A system, methods and apparatus in accordance with embodiments of the present disclosure is shown in the drawings for purposes of illustration. In the following description, numerous specific details are discussed to provide a thorough and enabling description for embodiments of the disclosure. One skilled in the relevant art, however, will recognize that the disclosure can be practiced without one or more of the specific details. In other instances, well-known structures or operations are not shown, or are not described in detail, to avoid obscuring aspects of the disclosure. In general, alternatives and alternate embodiments described herein are substantially similar to the previously described embodiments, and common elements are identified by the same reference numbers.

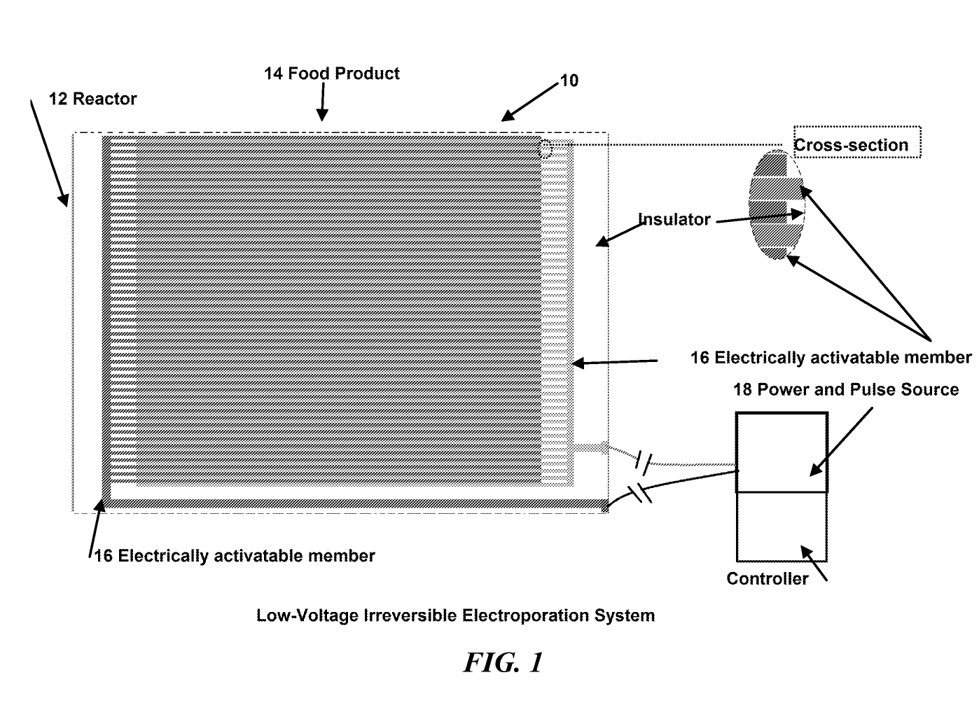

In one embodiment, the method, apparatus, and processes for making of food product, which includes foods, food ingredients, supplements, and/or bio-components, for human or animal consumption are provided substantially without the use of chemical preservatives, or thermal or radiation treatments for microbiological control, or addition of chemicals typically used to alter the pH as a preservation technique. FIG. 1 is a schematic illustration of a low-voltage irreversible electroporation and or electrolysis system 10 in accordance with an embodiment of the present disclosure. The system includes a reactor 12 configured to contain (transitorily, temporarily, short term or long term) the food product 14 being treated. Electrically activatable members 16 are coupled to the reactor 12 and in position for contacting the food product 14. The electrically activatable members 16 may be electrodes, such as electrodes of a high intensity pulsed electric field (PEF) device and they can be deposited onto or separated by an electric insulator. In other embodiments, the electrically activatable members can include conductive polymeric food grade materials (e.g. anti-microbial ion exchange resins, ceramic ion-exchange resins, etc) or polymer blends containing conductive polymeric materials subjectable a low voltage. In other embodiments, the electrically activatable members may include peptides or polypeptides in which the microorganisms are separated or killed when they attach to the polypeptide layer or membrane, or to polypeptides attached to a food grade material (e.g. stainless steel, SiO₂, cermets, ceramics, polymers, etc,) and are subjected or not to a low voltage, specifically peptides or polypeptides for food contact.

The electrically activatable members 16 are coupled to a power source 18, which may be coupled to a controller 20, to provide selected low voltage current thereto and to the food product during the low-voltage irreversible electroporation and or electrolysis operation. The power source may be remote from the reactor, connected to the reactor, or integrated into a portion of the reactor or other portion of a structure associated with the reactor for carrying the food product in position for direct engagement with the electrically activatable members.

The selected food product is subjected to one or more of the following food process operations or steps and a low-voltage irreversible electroporation and or electrolysis treatment operation. The following examples are provided for purposes of illustration, and other food process operations can be combined with the treatment process in accordance with other embodiments of the present technology.

(1) Separation or extraction: food product, such as natural foods are separated and/or components are extracted to produce juice or extract and by-products, and/or ingredients for other applications in food, pharmaceutical or others which involve organic material susceptible to be attacked by microorganisms. Then each juice, extract, component, and/or by-product can be treated using low-voltage irreversible electroporation and or electrolysis and/or electrolysis procedures to drastically reduce, control, or eliminate the microorganisms count and/or growth. Some products can be treated in the farm or place of growing or produced upon collection before being transported to larger processing units, and/or during transportation, and/or during storage, and/or during plant processing. Some products can be processed using water that has been treated using low voltage irreversible electroporation and or electrolysis and/or electrolysis procedures to drastically reduce, control, or eliminate the microorganisms count and/or growth in the water. Examples of such products and or its derivatives are and not limited to fruits, vegetables, dairy, grains, meats, fish, eggs, water, minerals, proteins, aminoacids, peptides, polypeptides, polysaccharides, collagen, hyaluronic acid, animal or human body fluids such as synovial fluid, blood, plasma, urine, bone marrow, etc. This separation or extraction process may be followed by one or more additional food process operations.

(2) Mixing: The food product can be subjected to a mixing operation. For example, the products from the above process 1 treated with low-voltage irreversible electroporation and or electrolysis methods can be mixed with natural foods, their separated and/or components extracted to produce juice or extract and by-products, and/or ingredients for other applications in food, pharmaceutical or others which involve organic material susceptible to be attacked by microorganisms, and or water that has been treated or not with low-voltage irreversible electroporation and or electrolysis methods. Such a mix may itself be treated with low-voltage irreversible electroporation and or electrolysis methods during or after the mixing process and may be followed by one or more additional process operations.

(3) Blending: The food product can be subjected to a blending operation. For example, the food products, which may be products from the above process 1 and/or 2 treated with the low-voltage irreversible electroporation and or electrolysis operation and/or electrolysis, can be blended with natural foods, their separated and/or components extracted to produce juice or extract and by-products, and/or ingredients for other applications in food, pharmaceutical or others which involve organic material susceptible to be attacked by microorganisms, and or water that has been treated or not with low-voltage and or electrolysis methods. Such a blend of food products may be treated with low-voltage irreversible electroporation and or electrolysis methods during or after the blending process and may be followed by one or more additional process operations. Some products can be blended using water that has been treated using low voltage irreversible electroporation and or electrolysis and/or electrolysis procedures to drastically reduce, control, or eliminate the microorganisms count and/or growth in the water.

(4) Concentration, Homogenization and/or emulsification: The food product can be subjected to a concentration, homogenization and/or emulsification operation. For example, the food products, which may be food products from the above process 1, 2, and/or 3 with the low-voltage irreversible electroporation and or electrolysis operation, can be concentrated, homogenized and/or emulsified during or after each process. The food product can be treated with low-voltage irreversible electroporation and or electrolysis methods during or after concentration, homogenization and/or emulsification, which may be in combination with natural foods, their separated and/or components extracted to produce juice or extract and by-products, and/or ingredients for other applications in food, pharmaceutical or others which involve organic material susceptible to be attacked by microorganisms, and or water that has been treated or not using low-voltage irreversible electroporation methods. The concentration, homogenization and/or emulsification process or operation may be followed by one or more additional process operations. Some emulsion or suspensions can be made using water that has been treated using low voltage irreversible electroporation and or electrolysis and/or electrolysis procedures to drastically reduce, control, or eliminate the microorganisms count and/or growth in the water.

(5) Cooking: The food product can be subjected to a cooking operation. For example, the food products, which may be food products from above processes 1, 2, 3, and/or 4 can be subjected to a cooking operation configured for the purposes of creating an interaction and/or reaction and/or synergistic effect between ingredients and it is not intended for pasteurization or sterilization process. However, this does not mean that if some microorganisms are present they could be destroyed also during the cooking process. The cooking can be done using thermal, and/or radiation, and/or electrical, and/or physical, and/or chemical methods. The products in this process can be treated using low voltage irreversible electroporation and or electrolysis during or after the cooking process. The cooking process may be followed by one or more additional process operations. Some products can be cooked using water that has been treated using low voltage irreversible electroporation and or electrolysis and/or electrolysis procedures to drastically reduce, control, or eliminate the microorganisms count and/or growth in the water.

(6) Cooling/Freezing: The food products can be subjected to a cooling and/or freezing operation. For example, the food products from above processes 1, 2, 3, 4, and/or 5 can be cooled down, refrigerated, or frozen during or after each process and/or during storage and/or during transportation. The products in this operation can be treated with low-voltage irreversible electroporation and or electrolysis methods during or after the cooling and/or freezing process. The cooling and/or freezing process may be followed one or more additional process operations.

(7) Filling: The food products can be subjected to a filling operation. For example, the food products from above processes 1, 2, 3, 4, 5, and/or 6 can be filled into containers using low-voltage irreversible electroporation and or electrolysis methods during or after the filling process.

Examples of the foods, food ingredients, supplements, and bio-components may include, but are not limited to: fruits, vegetables, dairy, grains, meats, fish, shell fish, seafood, eggs, water, minerals, proteins, modified proteins, aminoacids, peptides, polypeptides, native or modified polysaccharides (e.g. gums, starches, sugars, sweeteners), collagen, hyaluronic acid, animal or human body fluids such as synovial fluid, blood, blood serum, plasma, urine, bone marrow, polysorbates, mono- or di-glycerides, sterols, stanols, or phytosterols, polysaccharide like sugars (from sugarcane or beet or honey, agave, glucose, fructose, galactose, sucrose, maltose, lactose, etc) and/or natural sugar substitutes (hydrogenated starch hydrolysates like corn syrups or maltodextrins or dextrins, inulin, glycerol, erythritol, curculin, brazzein, glycerol, maltitol, isomalt, lactitol, mabinlin, malto-oligosaccharides, mannitol, miraculin, monatin, monellin, osladin, pentadin, pentadin, sorbitol, stevia, tagatose, thaumatin, xylito, Luo han guo) or artificial sugar substitutes (ACK, alitame, aspartame, cyclamate, salt of aspartame acesulfame, dulcin, glucin, neohesperidin dihydrochalcone, neotame, saccharin, sucralose, P4000), a peptide, a polypeptide, a vitamin (A, B1, B2, B3, B5, B6, B7, B9, B12, C, D, E, K), a mineral, pure or as in its salt form, (calcium, phosphorus, potassium, sulfur, sodium, chlorine, magnesium, manganese, iron, cobalt, copper, zinc, molybdenum, iodine, selenium, boron, chromium, arsenic, silicon, strontium, vanadium), an imminoacid, aminoacid (histidine, isoleucine, leucine, lysine, methionine, phenylalanine, threonine, tryptophan, valine, alanine, arginine, asparagines, aspartic acid, cysteine, glutamic acid, glutamine, glycine, ornithine, proline, selenocysteine, serine, taurine, tyrosine, gamma amino-butyric acid, hydroxyproline, selenomethionine, lanthionine, 2-aminoisobutyric acid, dehydroalanine, ornithine, citrulline, beta-alanine), coenzyme A, coenzyme Q, salt, stanols, sterols, phytosterols, lycopene, mono- and/or polyunsaturated fats lie Omega-3 (ALA, EPA, DHA), Omega-6 (GLA, DGLA, AA), arachiinodic, linoleic, Phytonutrients such as Natural monophenoils (apiole, carnosol, carvacrol, dillapiole) Flavonoids (quercetin, gingerole, kaempferol, myricetin, rutin, isorhamnetin) Flavanones (hesperidin, naringerin, silybin, eriodictyol) Flavones (apigenin, tangeritin, luteolin), flavan-3-ols (cathechins, gallocatechin, epicatechin, epigalocatechin, epigallocatechin gallate, epichatechin 3-gallate, theaflavin, theaflavion-3-gallate, theaflavin-3′-gallate, theaflavin-3-3′-digallate, thearubigins), anthocyaninns (pelargonidin, peonidin, cyaniding, delphinidin, malvidin, petudinin) Isoflavones (daidzein, genistein, glycitein) Dihydroflavonols, chalconoids, coumestans, phenolic acids (ellagic acid, gallic acid, salicylic acid, tannic acid, vanillin, capsaicin, curcumin) Hydroxycinnamic acids (caffeic acid, chlorogenic acid, cinnamic acid, ferulic acid, cumarin) lignans (silymarin, matairesinol, secoisolariciresinol, pinoresinol, lariciresinol) tyrosol esters (tyrosol, hydroxytyrosol, oleochanthal, oleuropein) stillbenoids (resveratol, pterostilbene, piceatannol), alkylresorcinols, carotenoids (alpha-carotene, beta-carotene, gamma-carotene, delta-carotene, lycopene, neuroperene, phytofluene, phytoene) Xantophylls (canthaxanthin, cryptoxanthin, zeaxanthin, astaxanthin, lutein, rubixanthin), Monoterpenes (limonene, perillyl alcohol), Saponins, phytosterols (campesterol, sitosterol, gamma-sytosterol, stigmasterols), tri-terpenoids (oleanolic acid, ursolic acid, betulinic acid, moronic acid) Betalains (betacyanins like betanin, isobetanin, probetanin, and beobetanin), betaxanthins like indicaxanthin and vulgaxanthin, Organosulfides (dithio)thiones like slphoraphane), polysilfides (allyl methyltrisulfide), Sulfides (diallylsulfides), Indole and glucosinolates (indole-3-caminol, sulphoraphane, sinigrin, allicin, alliin, allyl isothiocyanate, piperine, syn-propabethial-S-Oxide), protein inhibitors (oxakic acid, phytic acid, tartaric acid, anacardic acid), caffeine, fluoride, folic acid (or folate), dietary fiber, and protein hydrolysates.

### Example 1

An embodiment of the present disclosure is configured to provide a process for making emulsified beverages using low-voltage irreversible electroporation and or electrolysis. For example, the process is used for making oil-in-water beverage emulsions without the use of chemical preservatives or thermal treatments or addition of acid to get a high acid beverage as a preservation technique. The process steps may include (1) combining an oil mixture and an emulsifier containing aqueous mixture, (2) in-line mixing of the emulsion for a beverage, (3) homogenization to make a stable beverage emulsion, and (4) in-line low-voltage irreversible electroporation and or electrolysis that is applied in steps (1) for each mixture, and/or before the step for mixtures combined and/or after step (2) and/or after step (3) and/or after filling step.

In an example, the process is provided for making oil-in-water beverage emulsions without the use of chemical preservatives or thermal sterilization or pasteurization treatments or addition of acid to get a high acid beverage as preservation technique. The process steps can include steps (1) combining oil mixture with droplet size between approximately 0.01-1,000 microns, and preferably between approximately 0.01-50 microns and an emulsifier containing aqueous mixture. The process can include in-line mixing of the emulsion for a beverage to form a droplet size between approximately 0.01 to 50 microns, and preferably between approximately 0.01 and 20 microns; step (2) of homogenization to make a stable beverage emulsion with a final droplet size between approximately 0.01 to 20 microns, and preferably between approximately 0.01 to 1 micron; and/or step (3) applying the in-line low-voltage irreversible electroporation and or electrolysis operation in steps (1) for each mixture and/or before step (2) for mixtures combined and/or after step (2) and/or after step (3) and/or after a filling step or in the packaging, or combinations thereof.

The emulsifier can be a modified starch, pectin, or a gum, esters, polysorbates, mono- or di-glycerides, or combinations. The oil mixture may comprise a weighting agent, such as gum(s), ester gum(s), modified vegetable oil, sucrose acetate isobutyrate, colophony, or combinations thereof. The oil can be a vegetable oil, a modified vegetable oil, or mixtures thereof. The aqueous mixture may further comprises a natural or an artificial flavor and the mixtures thereof and/or natural fruit juice or fruit concentrate or their mixtures thereof, artificial or natural aromas or the mixture thereof, a coloring agent or mixtures thereof, and/or an acidulant for taste/flavor purpose that is natural or artificial and mixtures thereof.

The low-voltage irreversible electroporation and/or electrolysis is used to kill micro-organisms and/or parasites or to control micro-organism growth. The system utilizes a DC or AC power source, either by direct contact use or wireless (e.g. Near Field Communication) or combinations thereof. The low-voltage irreversible electroporation and or electrolysis operation is configured to kill micro-organisms and/or parasites or to control micro-organism growth in those components.

### Example 2

An embodiment of the present disclosure is configured to provide a process for making emulsified carbonated beverages using low-voltage irreversible electroporation and or electrolysis. The process is configured for making oil-in-water beverage emulsions without the use of chemical preservatives or thermal treatments or addition of acid to get a high acid beverage as a preservation technique. The process steps may include steps (1) combining oil mixture and an emulsifier containing aqueous mixture; step (2) of in-line mixing of the emulsion for a beverage; step (3) of homogenization to make a stable beverage emulsion; step (4) of carbonation or gas injection using CO₂ or N₂ or other carbonation technique; and step (5) of in-line low-voltage irreversible electroporation and or electrolysis in steps (1) for each mixture and/or before step for mixtures combined, and/or after step (2), and/or after step (3), and/or after filling step.

In an example, the process is provided for making oil-in-water beverage emulsions without the use of chemical preservatives or thermal sterilization treatments or addition of acid to get a high acid beverage as preservation technique. The process can include step (1) of combining an oil mixture with droplet size between approximately 0.01-1,000 microns, and preferably between approximately 0.01-50 microns, and an emulsifier containing aqueous mixture; step (2) of in-line mixing of the emulsion for a beverage to form a droplet size between approximately 0.01 to 50 microns, and preferably between approximately 0.01 and 20 microns; step (3) of homogenization to make a stable beverage emulsion with a final droplet size between approximately 0.01 to 20 microns, and preferably between approximately 0.01 to 1 micron; step (4) of carbonation or gas injection using CO₂ or N₂ or other carbonation technique; step (5) of in-line low-voltage irreversible electroporation and or electrolysis in steps (1) for each mixture and/or before step (2) for mixtures combined, and/or after step (2), and/or after step (3), and/or after filling step, or in the packaging, or combinations thereof.

In this example, the emulsifier can be either a polysaccharide, modified starch, pectin, or a gum, esters, polysorbates, mono- or di-glycerides, or combinations thereof. The oil mixture can comprise a weighting agent, such as gums, ester gums, modified vegetable oil, sucrose acetate isobutyrate, colophony, or combinations thereof. The oil can be a vegetable oil, a modified vegetable oil, or mixtures thereof. The aqueous mixture may further comprise a natural or an artificial flavor and the mixtures thereof, and/or natural fruit juice or fruit concentrate or their mixtures thereof, artificial or natural aromas or the mixture thereof, a coloring agent or mixtures thereof, and/or an acidulant for taste/flavor purpose that is natural or artificial and mixtures thereof. The carbonation process can be done by direct injection of using (a) CO₂ or N₂ or mixtures thereof, or (2) a pressurized device in the packaged beverage that contains CO₂ or N₂ or mixtures thereof and that is or are released upon de-pressurization of the contained. The pressurized device can contain natural or an artificial flavor and the mixtures thereof and/or natural fruit juice or fruit concentrate or their mixtures thereof, artificial or natural aromas or the mixture thereof, a coloring agent or mixtures thereof, and/or an acidulant for taste/flavor purpose that is natural or artificial and mixtures thereof.

The pressurized device can contain a low-voltage irreversible electroporation and or electrolysis unit that can kill micro-organisms and/or parasites or to control micro-organism growth. The low-voltage irreversible electroporation and or electrolysis unit has a power source (DC or AC) either by direct contact use or wireless (e.g. Near Field Communication) or combinations thereof.

### Example 3

Another embodiment of the present disclosure is configured to provide a method and process for making fortified beverages using low-voltage irreversible electroporation and or electrolysis. The process is configured for making fortified emulsified and non-emulsified, carbonated or not beverages without the use of chemical preservatives or thermal treatments or addition of acid to get a high acid beverage as a preservation technique. The process steps may include step (1) of mixing an oil mixture and an emulsifier containing aqueous mixture, wherein the mixing is mixed in-line for an emulsified beverage or an aqueous solution is mixed with water soluble ingredients; step (2) of in-line mixing or batch mixing of the emulsion or other ingredients for a beverage; step (3) of homogenization to make a stable beverage emulsion or solution; step (4) of adding fortified components prior to or after homogenization in step (3); step (5) may include carbonation by gas injection using CO₂ or N₂ or other carbonation technique; and step (6) of in-line low-voltage irreversible electroporation and or electrolysis in steps 1 for each mixture and/or before step for mixtures combined and/or after step 2 and/or after step 3 and/or after step 4 or after a filling step.

In an example, the process is provided for making fortified beverage without the use of chemical preservatives or thermal sterilization treatments or addition of acid to get a high acid beverage as preservation technique. The process can include step (1) of, for an emulsified beverage, combining oil mixture with droplet size between approximately 0.01-1,000 microns, and preferably between approximately 0.01-50 microns and an emulsifier containing aqueous mixture; step (2) of in-line mixing of the emulsion for a beverage to form a droplet size between approximately 0.01 to 50 microns, and preferably between approximately 0.01 and 20 microns or water soluble ingredients are mixed for non-emulsion beverages; step (3) of homogenization to make a stable beverage emulsion with a final droplet size between approximately 0.01 to 20 microns, and preferably between approximately 0.01 to 1 micron or further homogenization of aqueous solution with additional nutrients; step (4) of the addition of fortified components prior to or after homogenization in step (3); step (5) may include carbonation with gas injection using CO₂ or N₂ or other carbonation technique; and step (6) of in-line low-voltage irreversible electroporation and or electrolysis in step (1) for each mixture and/or before step (2) for mixtures combined and/or after step (2) and/or after step (3) and/or after a filling step or in the packaging or combinations thereof.

In this embodiment, the emulsifier can be a modified polysaccharide, starch, pectin, gum, esters, polysorbates, mono- or di-glycerides, a protein, a peptide or polypeptide, sterols, stanols, or phytostereols, or combinations thereof. The oil mixture can comprise a weighting agent, such as modified or not polysaccharide, gums, ester gums, starches, modified vegetable oil, sucrose acetate isobutyrate, colophony, proteins, or combinations thereof. The oil can be a vegetable oil, a modified vegetable oil, or mixtures thereof. The fortifying component, as regulated by FDA 21 CFR 104.20 and 45 FR 6316, and labeled under FDA 21 CFR 101 guidelines, can be a protein, a modified or not polysaccharide like sugars (from sugarcane or beet or honey, agave, glucose, fructose, galactose, sucrose, maltose, lactose) and/or natural sugar substitutes (hydrogenated starch hydrolysates like corn syrups or maltodextrins or dextrins, inulin, glycerol, erythritol, curculin, brazzein, glycerol, maltitol, isomalt, lactitol, mabinlin, malto-oligosaccharides, mannitol, miraculin, monatin, monellin, osladin, pentadin, pentadin, sorbitol, stevia, tagatose, thaumatin, xylito, Luo han guo) or artificial sugar substitutes (ACK, alitame, aspartame, cyclamate, salt of aspartame acesulfame, dulcin, glucin, neohesperidin dihydrochalcone, neotame, saccharin, sucralose, P4000), a peptide, a polypeptide, a vitamin (A, B1, B2, B3, B5, B6, B7, B9, B12, C, D, E, K), a mineral, pure or as in its salt form, (calcium, phosphorus, potassium, sulfur, sodium, chlorine, magnesium, manganese, iron, cobalt, copper, zinc, molybdenum, iodine, selenium, boron, chromium, arsenic, silicon, strontium, vanadium), an imminoacid, aminoacid (histidine, isoleucine, leucine, lysine, methionine, phenylalanine, threonine, tryptophan, valine, alanine, arginine, asparagines, aspartic acid, cysteine, glutamic acid, glutamine, glycine, ornithine, proline, selenocysteine, serine, taurine, tyrosine, gamma amino-butyric acid, hydroxyproline, selenomethionine, lanthionine, 2-aminoisobutyric acid, dehydroalanine, ornithine, citrulline, beta-alanine), coenzyme A, coenzyme Q, salt, stanols, sterols, phytosterols, lycopene, mono- and/or polyunsaturated fats lie Omega-3 (ALA, EPA, DHA), Omega-6 (GLA, DGLA, AA), arachiinodic, linoleic, Phytonutrients such as Natural monophenoils (apiole, carnosol, carvacrol, dillapiole) Flavonoids (quercetin, gingerole, kaempferol, myricetin, rutin, isorhamnetin) Flavanones (hesperidin, naringerin, silybin, eriodictyol) Flavones (apigenin, tangeritin, luteolin), flavan-3-ols (cathechins, gallocatechin, epicatechin, epigalocatechin, epigallocatechin gallate, epichatechin 3-gallate, theaflavin, theaflavion-3-gallate, theaflavin-3′-gallate, theaflavin-3-3′-digallate, thearubigins), anthocyaninns (pelargonidin, peonidin, cyaniding, delphinidin, malvidin, petudinin) Isoflavones (daidzein, genistein, glycitein)Dihydroflavonols, chalconoids, coumestans, phenolic acids (ellagic acid, gallic acid, salicylic acid, tannic acid, vanillin, capsaicin, curcumin) Hydroxycinnamic acids (caffeic acid, chlorogenic acid, cinnamic acid, ferulic acid, cumarin) lignans (silymarin, matairesinol, secoisolariciresinol, pinoresinol, lariciresinol) tyrosol esters (tyrosol, hydroxytyrosol, oleochanthal, oleuropein) stillbenoids (resveratol, pterostilbene, piceatannol), alkylresorcinols, carotenoids (alpha-carotene, beta-carotene, gamma-carotene, delta-carotene, lycopene, neuroperene, phytofluene, phytoene) Xantophylls (canthaxanthin, cryptoxanthin, zeaxanthin, astaxanthin, lutein, rubixanthin), Monoterpenes (limonene, perillyl alcohol), Saponins, phytosterols (campesterol, sitosterol, gamma-sytosterol, stigmasterols), tri-terpenoids (oleanolic acid, ursolic acid, betulinic acid, moronic acid) Betalains (betacyanins like betanin, isobetanin, probetanin, and beobetanin), betaxanthins like indicaxanthin and vulgaxanthin, Organosulfides (dithio)thiones like slphoraphane), polysilfides (allyl methyltrisulfide), Sulfides (diallylsulfides), Indole and glucosinolates (indole-3-caminol, sulphoraphane, sinigrin, allicin, alliin, allyl isothiocyanate, piperine, syn-propabethial-S-Oxide), protein inhibitors (oxakic acid, phytic acid, tartaric acid, anacardic acid), caffeine, fluoride, folic acid (or folate), dietary fiber, and protein hydrolysates.

The aqueous mixture can comprise a natural or an artificial flavor and the mixtures thereof and/or natural fruit juice or fruit concentrate or their mixtures thereof, artificial or natural aromas or the mixture thereof, a coloring agent or mixtures thereof, and/or an acidulant for taste/flavor purpose that is natural or artificial and mixtures thereof. The carbonation process can be done by direct injection of using (1) CO₂ or N₂ or mixtures thereof and/or (2) a pressurized device in the packaged beverage that contains CO₂ or N₂ or mixtures thereof and that is or are released upon de-pressurization of the contained. The pressurized device can contain natural or an artificial flavor and the mixtures thereof and/or natural fruit juice or fruit concentrate or their mixtures thereof, artificial or natural aromas or the mixture thereof, a coloring agent or mixtures thereof, and/or an acidulant for taste/flavor purpose that is natural or artificial and mixtures thereof.

The pressurized device can contain a low-voltage irreversible electroporation and or electrolysis unit configured for use to kill micro-organisms and/or parasites or to control micro-organism growth. A power source (DC or AC) is provided either by direct contact use or wireless (e.g. Near Field Communication) or combinations thereof. The above food product components can produced or not by using low-voltage irreversible electroporation and or electrolysis to kill micro-organisms and/or parasites or to control micro-organism growth in those components.

### Example 4

Another embodiment of the present disclosure is configured to provide a method and process for making non-emulsified beverages using low-voltage irreversible electroporation and or electrolysis. The process is configured for making a beverage without the use of chemical preservatives or thermal treatments or addition of acid to get a high acid beverage as a preservation technique. The process can include step (1) of combining water, and/or natural or artificial flavors, and/or natural or artificial aromas, and/or natural or artificial sweeteners, and/or natural or artificial essential oils, and/or fortifying components; step (2) of homogenization to make a stable beverage solution; step (3) of in-line low-voltage irreversible electroporation and or electrolysis in steps (1) for each liquid and/or before mixtures combined and/or after step (2) and/or after step (3) and/or after a filling step.

In this embodiment, the emulsifier can include the process for making a non-emulsified beverage without the use of chemical preservatives or thermal sterilization treatments or addition of acid to get a high acid beverage as preservation technique. The steps may include step (1) of combining water, natural or artificial flavors, natural or artificial aromas, natural or artificial sweeteners, natural or artificial essential oils; step (2) of homogenization to make a stable beverage solution; and step (3) of in-line low-voltage irreversible electroporation and or electrolysis in steps (1) for each liquid and/or before mixtures combined and/or after step (2) and/or after step (3) and/or after filling step.

In this embodiment, the process can include using a modified starch, pectin, or a gum, esters, polysorbates, mono- or di-glycerides, are used or combinations thereof. The aqueous mixture can further comprise a natural or an artificial flavor and the mixtures thereof and/or natural fruit juice or fruit concentrate or their mixtures thereof, artificial or natural aromas or the mixture thereof, a coloring agent or mixtures thereof, and/or an acidulant for taste/flavor purpose that is natural or artificial and mixtures thereof. The fortifiying component, as regulated by FDA 21 CFR 104.20 and 45 FR 6316, and labeled under FDA 21 CFR 101 guidelines, can be a protein, a modified or not polysaccharide like sugars (from sugarcane or beet or honey, agave, glucose, fructose, galactose, sucrose, maltose, lactose) and/or natural sugar substitutes (hydrogenated starch hydrolysates like corn syrups or maltodextrins or dextrins, inulin, glycerol, erythritol, curculin, brazzein, glycerol, maltitol, isomalt, lactitol, mabinlin, malto-oligosaccharides, mannitol, miraculin, monatin, monellin, osladin, pentadin, pentadin, sorbitol, stevia, tagatose, thaumatin, xylito, Luo han guo) or artificial sugar substitutes (ACK, alitame, aspartame, cyclamate, salt of aspartame acesulfame, dulcin, glucin, neohesperidin dihydrochalcone, neotame, saccharin, sucralose, P4000), a peptide, a polypeptide, a vitamin (A, B1, B2, B3, B5, B6, B7, B9, B12, C, D, E, K), a mineral, pure or as in its salt form, (calcium, phosphorus, potassium, sulfur, sodium, chlorine, magnesium, manganese, iron, cobalt, copper, zinc, molybdenum, iodine, selenium, boron, chromium, arsenic, silicon, strontium, vanadium), an imminoacid, aminoacid (histidine, isoleucine, leucine, lysine, methionine, phenylalanine, threonine, tryptophan, valine, alanine, arginine, asparagines, aspartic acid, cysteine, glutamic acid, glutamine, glycine, ornithine, proline, selenocysteine, serine, taurine, tyrosine, gamma amino-butyric acid, hydroxyproline, selenomethionine, lanthionine, 2-aminoisobutyric acid, dehydroalanine, ornithine, citrulline, beta-alanine), coenzyme A, coenzyme Q, salt, stanols, sterols, phytosterols, lycopene, mono- and/or polyunsaturated fats lie Omega-3 (ALA, EPA, DHA), Omega-6 (GLA, DGLA, AA), arachiinodic, linoleic, Phytonutrients such as Natural monophenoils (apiole, carnosol, carvacrol, dillapiole) Flavonoids (quercetin, gingerole, kaempferol, myricetin, rutin, isorhamnetin) Flavanones (hesperidin, naringerin, silybin, eriodictyol) Flavones (apigenin, tangeritin, luteolin), flavan-3-ols (cathechins, gallocatechin, epicatechin, epigalocatechin, epigallocatechin gallate, epichatechin 3-gallate, theaflavin, theaflavion-3-gallate, theaflavin-3′-gallate, theaflavin-3-3′-digallate, thearubigins), anthocyaninns (pelargonidin, peonidin, cyaniding, delphinidin, malvidin, petudinin) Isoflavones (daidzein, genistein, glycitein)Dihydroflavonols, chalconoids, coumestans, phenolic acids (ellagic acid, gallic acid, salicylic acid, tannic acid, vanillin, capsaicin, curcumin) Hydroxycinnamic acids (caffeic acid, chlorogenic acid, cinnamic acid, ferulic acid, cumarin) lignans (silymarin, matairesinol, secoisolariciresinol, pinoresinol, lariciresinol) tyrosol esters (tyrosol, hydroxytyrosol, oleochanthal, oleuropein) stillbenoids (resveratol, pterostilbene, piceatannol), alkylresorcinols, carotenoids (alpha-carotene, beta-carotene, gamma-carotene, delta-carotene, lycopene, neuroperene, phytofluene, phytoene) Xantophylls (canthaxanthin, cryptoxanthin, zeaxanthin, astaxanthin, lutein, rubixanthin), Monoterpenes (limonene, perillyl alcohol), Saponins, phytosterols (campesterol, sitosterol, gamma-sytosterol, stigmasterols), tri-terpenoids (oleanolic acid, ursolic acid, betulinic acid, moronic acid) Betalains (betacyanins like betanin, isobetanin, probetanin, and beobetanin), betaxanthins like indicaxanthin and vulgaxanthin, Organosulfides (dithio)thiones like slphoraphane), polysilfides (allyl methyltrisulfide), Sulfides (diallylsulfides), Indole and glucosinolates (indole-3-caminol, sulphoraphane, sinigrin, allicin, alliin, allyl isothiocyanate, piperine, syn-propabethial-S-Oxide), protein inhibitors (oxakic acid, phytic acid, tartaric acid, anacardic acid), caffeine, fluoride, folic acid (or folate), dietary fiber, and protein hydrolysates.

In this embodiment, the low-voltage irreversible electroporation and or electrolysis is used to kill micro-organisms and/or parasites or to control micro-organism growth. The low-voltage irreversible electroporation and/or electrolysis includes using a power source (DC or AC) either by direct contact use or wireless (e.g. Near Field Communication) or combinations thereof. Each of the food product components can be produced by using low-voltage irreversible electroporation and or electrolysis to kill micro-organisms and/or parasites or to control micro-organism growth in those components.

### Example 5

Another embodiment of the present disclosure is configured to provide a process for making non-emulsified carbonated beverages using low-voltage irreversible electroporation and or electrolysis. The process is configured for making a beverage without the use of chemical preservatives or thermal treatments or addition of acid to get a high acid beverage as a preservation technique. The process steps can include step (1) of combining water, natural or artificial flavors, natural or artificial aromas, natural or artificial sweeteners, natural or artificial essential oils; step (2) of homogenization to make a stable beverage solution; step (3) of a carbonation or gas injection using CO2 or N2 or other carbonation technique; and step (4) of in-line low-voltage irreversible electroporation and or electrolysis in steps (1) for each liquid and/or before mixtures combined and/or after step (2) and/or after step (3) and/or after a filling step.

In this embodiment, the process can include using a modified starch, pectin, or a gum, esters, polysorbates, mono- or di-glycerides, are used or combinations thereof. The process can uses an aqueous mixture that can include a natural or an artificial flavor and the mixtures thereof and/or natural fruit juice or fruit concentrate or their mixtures thereof, artificial or natural aromas or the mixture thereof, a coloring agent or mixtures thereof, and/or an acidulant for taste/flavor purpose that is natural or artificial and mixtures thereof. The carbonation process can be done by direct injection of using (a) CO2 or N2 or mixtures thereof and/or (2) a pressurized device in the packaged beverage that contains CO2 or N2 or mixtures thereof and that is or are released upon de-pressurization of the contained. The pressurized device can contain natural or an artificial flavor and the mixtures thereof and/or natural fruit juice or fruit concentrate or their mixtures thereof, artificial or natural aromas or the mixture thereof, a coloring agent or mixtures thereof, and/or an acidulant for taste/flavor purpose that is natural or artificial and mixtures thereof.

The pressurized device can contain a low-voltage irreversible electroporation and or electrolysis unit configured to kill micro-organisms and/or parasites or to control micro-organism growth. The low-voltage irreversible electroporation and or electrolysis unit can include a power source (DC or AC) that provides low-voltage power either by direct contact use or wireless (e.g. Near Field Communication) or combinations thereof.

### Example 6

Another embodiment of the present disclosure is configured to provide a process for processing milk and milk by-products using low-voltage irreversible electroporation and or electrolysis. The process is configured for processing the milk and milk-by-products without the use of chemical preservatives or thermal treatments for preservation. The process steps can include step (1) of collection of the milk; step (2) of milk reception, which may include step (2a) of milk cooling, step (2b) of milk transportation; and/or step (2c) of milk storing; step (3) of milk processing, which may include step (3a) of standardization, step (3b) of separation, step (3c) of homogenization, and/or step (3d) of storing; step (4) of product processing, which may include step (4a) of concentration, step (4b) of drying, step (4c) of fermentation, step (4d) of coagulation, step (4e) of butter processing, step (4f) of freezing, and/or step (4g) of packaging; step (5) of storage; step (6) of distribution; and step (7) of in-line low-voltage irreversible electroporation and or electrolysis after steps 1, 2a, 2b, 3a, 3b, 3c, 3d, 4a, 4c, 4d, 4e, 4g, 5, and/or 6.

In this embodiment, the source of milk can be from mammals, including but not limited to cattle, buffalo, goat, sheep, camel, donkey, horse, reindeer, or yak. The milk does not need to be neither pasteurized, sterilized, nor ultra-filtered for microbial control purposes. The low-voltage irreversible electroporation and or electrolysis is used to kill micro-organisms and/or parasites or to control micro-organism growth. The low-voltage irreversible electroporation and or electrolysis process uses a power source (DC or AC), wherein power is provided by direct contact, such as via portions of the power source embedded in a food grade non-conductive material, or provided wirelessly wireless (e.g. Near Field Communication), or combinations thereof.

The low-voltage irreversible electroporation and or electrolysis system can be used in any one or more of (1) in the tank where the raw milk is collected directly from the mammal at room temperature conditions or under cooling; (2) in a car or other vehicle transporting the raw milk to a reception center with or without a cooling system; (3) in a tank storing the raw milk in a reception center at room temperature or cooling conditions; (4) in-line when pumping the milk from a truck transporting the raw milk to the tank in the reception center at room temperature or cooling conditions; (5) during milk processing at room temperature conditions; (6) during raw milk standardization process in-line; (7) in-line during fat separation after the standardization process; (8) before or during the homogenization processes or combinations thereof; (9) in-line after the homogenization process before or during storage or combinations thereof in the milk processing stage; (10) in-line before, during, or after filtering raw milk for retail; (11) in-line before, during, or after producing fresh whole milk; (12) in-line before, during, or after producing low-fat milk; (13) in-line before, during, or after producing skimmed milk; (14) in-line before, during, or after producing part-skim condensed milk; (15) in-line before, during, or after producing condensed skim milk; (16) in-line before or during producing powdered skim milk; and/or (17) in-line before, during, or after producing flavored milk. In other embodiments, the low-voltage irreversible electroporation and or electrolysis system may be used in other processing steps under which the milk or milk-based product undergoes.

In this embodiment, the flavor may be natural or artificial, and the flavor could be made or processed using low-voltage irreversible electroporation and or electrolysis system at any stage of their production line.

In this embodiment, the low-voltage irreversible electroporation and or electrolysis system could be used in any one or more of (1) in-line before, during, or after producing condensed evaporated milk; (2) in-line to control the growth of lactobacillus in the production of soured milk; (3) in-line to control the growth of lactobacillus in the production of organic yoghurt, mild yoghurt, yoghurt, cream yoghurt, or buttermilk; (4) in-line to control the growth of kefir culture in the production of kefir; (5) in-line to control the process of making different types of cheese curd; (6) in-line to control the process in the production of quark; (7) in-line to control the process in the production of sour whey; (8) in-line to control the process in the production of different types of cream cheese; (9) in-line to control the process in the production of different types of sour milk cheese; (10) in-line to control the process of making different types of sweet whey; (11) in-line to control the process of making different types of fresh cottage cheese; (12) in-line to control the process of making different types of fresh whey cheese; (13) in-line to control the microorganism growth and process of making different types of soft or soft ripened cheese, semi-soft cheese, semi-hard cheese, hard cheese, or blue vein cheese; (14) in-line to control the microorganism growth and process of making different types of brined or pasta filata cheese; (15) in-line in the production of producing clotted cream; (16) in-line before, during, or after separating the raw milk into low fat to skimmed raw milk and cream; (17) in-line to control microorganism growth in order to produce different types of soured cream; (18) in-line in order to produce different types of condensed cream; (19) in-line in order to produce different types of half-and-half, table cream, whipping cream, and double cream; (20) in-line in order to control microorganisms growth in the liquid separated during butter production; (21) in-line in order to produce different types of condensed cream: (22) in-line in order to produce different types of butter fat, mild cultured butter, and clarified butter; (23) in-line in order to produce different types of raw cream butter; (24) in-line in order to produce different types of cultured butter, sour cream, schmand, and crème fraiche; (25) in-line in order to produce different types of mascarpone cheese; and/or (26) in line before, during or after production, packaging, distribution, or storage of other milk or milk-based products.

### Example 7

Another embodiment of the present disclosure is configured to provide a process for making fruit juice and fruit concentrates using low-voltage irreversible electroporation and or electrolysis. The process is configured for making juice (emulsified or not, carbonated or not) and fruit concentrates without the use of chemical preservatives or thermal treatments for preservation or addition of acid to get a high acid beverage or concentrate as a preservation technique. The process steps can include step (1) of juice extraction; step (2) of juice concentration for concentrated products; step (3) of mixing in-line an oil mixture and an emulsifier containing a fruit juice mixture to obtain an emulsified beverage and are mixed with water soluble ingredients; step (4) of in-line mixing or batch mixing of the emulsion or other ingredients for a beverage; step (5) of homogenization to make a stable beverage emulsion or solution; step (6) of the addition of fortified components prior to or after homogenization in step (4); step (7) of carbonation by gas injection using CO₂ or N₂ or other carbonation techniques; and step (8) of in-line low-voltage irreversible electroporation and or electrolysis after step (1), or in step (3) for each mixture, and/or before step (4) step for mixtures combined, and/or after steps (5) and/or step (6) or after a filling step, a packaging step, and/or a combination thereof.

In this embodiment, the emulsifier can be either a polysaccharide (modified or not (e.g., starches, acid polysaccharides, glycogen, arabinoxylans, cellulose, chitin, pectin, bacterial polysaccharides, bacterial capsular polysaccharides)), a protein (modified or not), a peptide or polypeptide (modified or not), polysorbates, mono- or di-glycerides, a protein, sterols, stanols, or phytostereols, or combinations thereof. The oil mixture can include a weighting agent such as modified or not polysaccharides, gums, ester gums, starches, modified vegetable oil or not, sucrose acetate isobutyrate, colophony, modified proteins or not, or combinations thereof. The oil can be a vegetable oil, a modified vegetable oil, or mixtures thereof. The fortifiying component, as regulated by FDA 21 CFR 104.20 and 45 FR 6316, and labeled under FDA 21 CFR 101 guidelines, can be a protein, a carbohydrate like sugars (from sugarcane or beet or honey, agave, glucose, fructose, galactose, sucrose, maltose, lactose) and/or natural sugar substitutes (hydrogenated starch hydrolysates like corn syrups or maltodextrins or dextrins, inulin, glycerol, erythritol, curculin, brazzein, glycerol, maltitol, isomalt, lactitol, mabinlin, malto-oligosaccharides, mannitol, miraculin, monatin, monellin, osladin, pentadin, pentadin, sorbitol, stevia, tagatose, thaumatin, xylito, Luohanguo) or artificial sugar substitutes (AceK, alitame, aspartame, cyclamate, salt of aspartame acesulfame, dulcin, glucin, neohesperidindihydrochalcone, neotame, saccharin, sucralose, P4000), a peptide, a polypeptide, a vitamin (A, B1, B2, B3, B5, B6, B7, B9, B12, C, D, E, K), a mineral, pure or as in its salt form, (calcium, phosphorus, potassium, sulfur, sodium, chlorine, magnesium, manganese, iron, cobalt, copper, zinc, molybdenum, iodine, selenium, boron, chromium, arsenic, silicon, strontium, vanadium), an imminoacid, aminoacid (histidine, isoleucine, leucine, lysine, methionine, phenylalanine, threonine, tryptophan, valine, alanine, arginine, asparagines, aspartic acid, cysteine, glutamic acid, glutamine, glycine, ornithine, proline, selenocysteine, serine, taurine, tyrosine, gamma amino-butyric acid, hydroxyproline, selenomethionine, lanthionine, 2-aminoisobutyric acid, dehydroalanine, ornithine, citrulline, beta-alanine), coenzyme A, coenzyme Q, salt, stanols, sterols, phytosterols, lycopene, mono- and/or polyunsaturated fats lie Omega-3 (ALA, EPA, DHA), Omega-6 (GLA, DGLA, AA), arachiinodic, linoleic, Phytonutrients such as Natural monophenoils (apiole, carnosol, carvacrol, dillapiole) Flavonoids (quercetin, gingerole, kaempferol, myricetin, rutin, isorhamnetin) Flavanones (hesperidin, naringerin, silybin, eriodictyol) Flavones (apigenin, tangeritin, luteolin), flavan-3-ols (cathechins, gallocatechin, epicatechin, epigalocatechin, epigallocatechingallate, epichatechin 3-gallate, theaflavin, theaflavion-3-gallate, theaflavin-3′-gallate, theaflavin-3-3′-digallate, thearubigins), anthocyaninns (pelargonidin, peonidin, cyaniding, delphinidin, malvidin, petudinin) Isoflavones (daidzein, genistein, glycitein)Dihydroflavonols, chalconoids, coumestans, phenolic acids (ellagic acid, gallic acid, salicylic acid, tannic acid, vanillin, capsaicin, curcumin) Hydroxycinnamic acids (caffeic acid, chlorogenic acid, cinnamic acid, ferulic acid, cumarin) lignans (silymarin, matairesinol, secoisolariciresinol, pinoresinol, lariciresinol) tyrosol esters (tyrosol, hydroxytyrosol, oleochanthal, oleuropein) stillbenoids (resveratol, pterostilbene, piceatannol), alkylresorcinols, carotenoids (alpha-carotene, beta-carotene, gamma-carotene, delta-carotene, lycopene, neuroperene, phytofluene, phytoene) Xantophylls (canthaxanthin, cryptoxanthin, zeaxanthin, astaxanthin, lutein, rubixanthin), Monoterpenes (limonene, perillyl alcohol), Saponins, phytosterols (campesterol, sitosterol, gamma-sytosterol, stigmasterols), tri-terpenoids (oleanolic acid, ursolic acid, betulinic acid, moronic acid) Betalains (betacyanins like betanin, isobetanin, probetanin, and beobetanin), betaxanthins like indicaxanthin and vulgaxanthin, Organosulfides (dithio)thiones like slphoraphane), polysilfides (allylmethyltrisulfide), Sulfides (diallylsulfides), Indole and glucosinolates (indole-3-caminol, sulphoraphane, sinigrin, allicin, alliin, allylisothiocyanate, piperine, syn-propabethial-S-Oxide), protein inhibitors (oxakic acid, phytic acid, tartaric acid, anacardic acid), caffeine, fluoride, folic acid (or folate), dietary fiber, and protein hydrolysates.

The process can include the aqueous mixture that includes a natural or an artificial flavor and the mixtures thereof and/or natural fruit juice or fruit concentrate or their mixtures thereof, artificial or natural aromas or the mixture thereof, a coloring agent or mixtures thereof, and/or an acidulant for taste/flavor purpose that is natural or artificial and mixtures thereof. The carbonation process can be done by direct injection using (1) CO₂ or N₂ or mixtures thereof, and/or (2) a pressurized device in the packaged beverage that contains CO₂ or N₂ or mixtures thereof and that is or are released upon de-pressurization of the container. The pressurized device can contain natural or an artificial flavor and the mixtures thereof and/or natural fruit juice or fruit concentrate or their mixtures thereof, artificial or natural aromas or the mixture thereof, a coloring agent or mixtures thereof, and/or an acidulant for taste/flavor purpose that is natural or artificial and mixtures thereof.

The pressurized device can contain a low-voltage irreversible electroporation and or electrolysis unit used to kill micro-organisms and/or parasites or to control micro-organism growth. The low-voltage irreversible electroporation and or electrolysis unit can include a power source (DC or AC) that provides low-voltage power either by direct contact use or wirelessly (e.g. Near Field Communication) or combinations thereof. The food product or components thereof produced or processed using low-voltage irreversible electroporation and or electrolysis to kill micro-organisms and/or parasites or to control micro-organism growth in those components.

From the foregoing, it will be appreciated that specific embodiments of the invention have been described herein for purposes of illustration, but that various modifications may be made without deviating from the invention. Additionally, aspects of the invention described in the context of particular embodiments or examples may be combined or eliminated in other embodiments. Although advantages associated with certain embodiments of the invention have been described in the context of those embodiments, other embodiments may also exhibit such advantages. Additionally, not all embodiments need necessarily exhibit such advantages to fall within the scope of the invention. Accordingly, the invention is not limited except as by the appended claims.

I claim:

1. A system for processing consumable food products using irreversible electroporation or electrolysis, the system being coupleable to a power source, the system comprising:
a reactor having an interior area configured to contain a consumable food product, the reactor being configured to enable the food product to move within the reactor;
a controller coupled to the reactor and coupleable to the power source; and
electrically activatable members connected to the reactor, at least a portion of the electrically activatable members being positioned in the interior area of the reactor and in a location for contact with the food product when the food product moves within the reactor; the electrically activatable members being coupled to the controller and configured to receive an electrical current from the power source and to apply a selected low voltage current to the food product moving within the reactor and contacting the electrically activatable members in a manner that separates or kills all microorganisms in the food product via low-voltage, irreversible electroporation or electrolysis.

2. The system of claim 1 wherein the electrically activatable members have food engagement surfaces comprising conductive food-grade polymeric materials configured to apply the low voltage current directly to the food product upon engagement with the engagement surfaces.

3. The system of claim 2 wherein the conductive food-grade polymeric materials comprised one or more anti-microbial ion exchange resins, or ceramic ion-exchange resins.

4. The system of claim 1 wherein the electrically activatable members have food engagement surfaces comprising a food-grade carrier and layer of peptides or polypeptides on at least a portion of the carrier in a position to contact the food product in the reactor, the layer of peptides or polypeptides being configured to connect to microorganisms in the food product contacting the layer, whereby the microorganisms are killed or separated from the food product upon application of the low-voltage current to the carrier of the electrically activatable members.

5. The system of claim 1 wherein the electrically activatable members comprise a high-intensity pulsed electronic field device configured to apply to the food product electrical pulses with low voltage to kill any microorganisms in the food product.

6. The system of claim 5 wherein the high-intensity pulsed electronic field device comprise a plurality of electrodes made of food-grade materials and coupled to the power source and spaced apart from each other by an insulator members.

7. The system of claim 1 wherein the electrically activatable members comprise a plurality of electrodes made of food-grade materials and coupled to the power source and spaced apart from each other by an insulator members.

8. The system of claim 1, further comprising a food processing device configured to separate, extract, mix or blend components of the food product, wherein at least one of the components of the food product processed by the food processing device is directed into engagement with the electrically activatable members in a manner that separates or kills all microorganisms in the food product via the low-voltage, irreversible electroporation or electrolysis.

9. The system of claim 1 further comprising a food processing device configured to concentrate, homogenize, emulsify, cook, cool, freeze, or fill components of the food product, wherein at least one of the components of the food product processed by the food processing device is directed into engagement with the electrically activatable members in a manner that separates or kills all microorganisms in the food product via the low-voltage, irreversible electroporation or electrolysis.

10. The system of claim 1 wherein the reactor is a continuous flow vessel configured for a substantially continuous flow of the food product therethrough along a path for direct contact with the electrically activatable members.

11. The system of claim 1 wherein the reactor is a vessel comprising an actuatable member configured cause the food product to move within the vessel for direct contact with the electrically activatable members.

12. The system of claim 1 wherein the electrically activatable members comprise a high intensity pulsed electric field device configured to provide electric pulses to the food product, wherein the electric pulses have a voltage in the range of approximately 1×10⁻²⁴-2000 Volts, with electric fields in the magnitude range of approximately 50 V/cm to 60 KV/cm, and pulse lengths in the range of approximately 10⁻¹² to 1 second with a duration in the range of approximately 10⁻¹² to 100 seconds.

13. The system of claim 12, wherein the high intensity pulsed electric field device comprises a plurality of electrodes arranged in parallel sequence, side by side, with an electric insulator between the electrodes.

14. A method of processing consumable products for consumption by humans or animals to kill substantially all disadvantageous microorganisms therein without sterilization, pasteurization, or use of preservative additives, the method comprising:
retaining the consumable product in an interior area of reactor, wherein the consumable product has not previously been sterilized, pasteurized, or received preservative additives;
activating a controller coupled to a power source and to the reactor, the controller being operatively coupled to electrically activatable members positioned at least partially within the reactor, the electrically activatable members being configured for low-voltage, irreversible electroporation or electrolysis;
directing a low voltage current through the electrically activatable members connected to the reactor, at least a portion of the electrically activatable members being positioned in the interior area for contact with the consumable product when the consumable product moves within the reactor; and
moving the consumable product relative to the electrically activatable members, wherein the consumable product directly contacts with the electrically activatable members, wherein the low voltage current from the electrically activatable members is applied directly to the consumable product in contact with the electrically activatable members killing or removing substantially all microorganisms in the food product via the low-voltage, irreversible electroporation or electrolysis.

15. The method of claim 14 wherein retaining the consumable product includes retaining an edible food product configured for human consumption in the interior area of the reactor.

16. The method of claim 14, wherein retaining the consumable product includes retaining an edible liquid food product configured for human or pet consumption in the interior area of the reactor.

17. The method of claim 14, wherein directing the low-voltage current comprises applying a plurality of electric pulses directly to the food product in the interior area, wherein the electric pulses have a voltage in the range of approximately 1×10⁻²⁴-2000 Volts, with electric fields in the magnitude range of approximately 50 V/cm to 60 KV/cm, and pulse lengths in the range of approximately 10⁻¹² to 1 second with a duration in the range of approximately 10⁻¹² to 100 seconds.

18. The method of claim 14, further comprising processing with a processing device the consumable product to concentrate, homogenize, emulsify, cook, cool, freeze, or fill components of the consumable product, wherein at least one of the components of the consumable product processed by the processing device is directed into engagement with the electrically activatable members in a manner that separates or kills all microorganisms in the consumable product via the low-voltage, irreversible electroporation or electrolysis.

19. The method of claim 14, wherein moving the consumable product includes blending, mixing, agitating, stirring or pushing the consumable product to cause the consumable product to move within the interior area of the reactor and into direct contact with the electrically activatable members.

20. An irreversible electroporation or electrolysis assembly coupleable to a power source, the system comprising:
a reactor configured to contain an unpasteurized, unsterilized, edible food product for human or animal consumption; and
electrically activatable members connected to the reactor and positioned wherein the edible food product moves relative to the electrically activatable members, at least a portion of the electrically activatable members being positioned for directly contacting at least portions of the food product that may contain live, unwanted microorganisms, the electrically activatable members being coupled to the power source and configured to receive an electrical current therefrom and to apply a selected low voltage current directly to the food product contacting the electrically activatable members in a manner that separates or kills the unwanted microorganisms in the edible food product via low-voltage, irreversible electroporation or electrolysis.
